(19) United States
(12) Patent Application Publication
(10) Pub. No.: US 2016/0211526 A1
(43) Pub. Date: Jul. 21, 2016

(54) COLLECTOR ALUMINUM FOIL, SECONDARY BATTERY, AND EVALUATION METHOD

(71) Applicant: NEC Corporation, Minato-ku, Tokyo (JP)

(72) Inventor: Akio TODA, Tokyo (JP)

(21) Appl. No.: 14/914,471

(22) PCT Filed: Aug. 20, 2014
(86) PCT No.: PCT/JP2014/004261

§ 371 Date: Feb. 25, 2016

(30) Foreign Application Priority Data
Sep. 9, 2013 (JP) 2013-186559
Mar. 28, 2014 (JP) 2014-068369

(51) Int. Cl. H01M 4/66; G01N 23/20; H01M 4/70

(52) U.S. Cl. CPC H01M 4/661; H01M 4/70; G01N 23/20091

(57) ABSTRACT

The mechanical strength of an electrode sheet becomes problematic when employing means for improving the productivity of an electrode process. In a collector aluminum foil of the present invention, when the intensities of the (022) and (111) diffraction peaks appearing in an XRD spectrum measured in the reflection geometry are denoted by I_{B}(022) and I_{B}(111), respectively, a value of I_{B}(022)/I_{B}(111) is 200 or less.

### TECHNICAL FIELD

The present invention relates to a collector aluminum foil, a secondary battery, and an evaluation method, and more particularly to a collector aluminum foil which is less liable to break, a secondary battery, and an evaluation method.

### BACKGROUND ART

In general, a metallic foil is used as a collector in a secondary battery. Properties required for a collector include low electric resistance, chemical resistance against an electrolytic solution and the like, and good electrical contact with an electrode material. In addition to the properties described above, further enhancement of mechanical strength of a collector foil is desirable in order to provide a high-speed electrode manufacturing process which has been ongoing in recent years aiming for increased electrode productivity.

Means for increasing productivity of an electrode process includes, for example, high-speed coating and so-called hot pressing described below.

The high-speed coating refers to use of increased speeds in unwinding and winding of an electrode sheet in a process of coating a metallic foil collector with electrode slurry (composed of an electrode active material, a conductive assistant, a binder, a thickener, and the like).

The hot pressing refers to a process of pressing an electrode sheet while heating, after applying electrode slurry to a collector, and is capable of adjusting electrode density and the like, and ensuring electrical contact between an active material and a collector, even under decreased pressing pressure.

Regarding the aforementioned issue, Patent Literature 1 (PTL1) describes a technology for enhancing strength of an aluminum foil by so-called solid solution hardening caused by introducing an impurity atom into an aluminum foil.

### CITATION LIST

### Patent Literature

[PTL1] Japanese Laid-open Patent Application No. 2011-89196

[PTL2] Japanese Laid-open Patent Application No. 2009-245788

### SUMMARY OF INVENTION

### Technical Problem

However, mechanical strength of an electrode sheet becomes a problem as described above, in adopting the productivity increasing means.

For example, the high-speed coating involves a higher tensile force to be applied in a longitudinal direction of a sheet than a common coating method at the time of winding. Further, while a compressive force is applied in an electrode thickness direction in a pressing process of an electrode sheet, a plurality of pairs of rolls are used in the hot pressing as disclosed in, for example, Patent Literature 2 (PTL2), and therefore, a tensile force is applied to an electrode sheet between rolls in addition to the compressive force in the electrode thickness direction. Consequently, strength against tension in a rolling direction of electrode sheet surface in addition to strength against weighting in the electrode thickness direction is an issue in the hot pressing. In fact, a phenomenon of an electrode sheet breaking caused by hot pressing is observed in some collector aluminum foils.

An object of the present invention is to provide a collector aluminum foil, a secondary battery, and an evaluation method, solving the aforementioned problem.

### Solution to Problem

In a first collector aluminum foil according to the present invention, a value of I_{B}(022)/I_{B}(011) expressed by I_{B}(022), denoting an intensity of a (022) diffraction peak appearing in an XRD spectrum measured in a reflection geometry, and I_{B}(111), denoting an intensity of a (111) diffraction peak, is 200 or smaller.

In a second collector aluminum foil according to the present invention, a value of I_{B}(022)/I_{B}(002) expressed by I_{B}(022), denoting an intensity of a (022) diffraction peak appearing in an XRD spectrum measured in a reflection geometry, and I_{B}(002), denoting an intensity of a (002) diffraction peak, is 10 or smaller.

In a third collector aluminum foil according to the present invention, a value of I_{LR}(111)/I_{LR}(002) expressed by I_{LR}(111), denoting an intensity of a (111) diffraction peak, appearing in an XRD spectrum measured in a transmission geometry and in a manner that a 2θ axis makes 90° with a rolling direction, and I_{LR}(002), denoting an intensity of a (002) diffraction peak, is 35 or greater.

In a fourth collector aluminum foil according to the present invention, a value of I_{LR}(111)/I_{LR}(022) expressed by the I_{LR}(111), denoting the intensity of a (111) diffraction peak appearing in an XRD spectrum measured in a transmission geometry and in a manner that a 2θ axis makes 90° with a rolling direction, and I_{LR}(022), denoting an intensity of a (022) diffraction peak, is 760 or greater.

In a fifth collector aluminum foil according to the present invention, a value of I₁/I₀ expressed by I₀, denoting an intensity of, out of two (022) diffraction peaks in a direction normal to a rolled surface, respectively derived from a CuKα1 radiation and a CuKα2 radiation of an incident X-ray, appearing in an XRD spectrum measured in a reflection geometry, a (022) diffraction peak derived from the CuKα1 radiation, and I₁, denoting an intensity at a valley formed by an overlap of the two (022) diffraction peaks, is 0.22 or greater.

In a sixth collector aluminum foil according to the present invention, a (022) X-ray rocking curve measured in a reflection geometry and in a manner that a 2θ axis makes 90° with a rolling direction, has a minimum value at an incident angle of an incident X-ray in a range from 30° to 35°, and a first maximum value and a second maximum value at the incident angles in ranges from 15° to 20° and from 47° to 52°, respectively.

In a seventh collector aluminum foil according to the present invention, a peak intensity corresponding to (122) or (123) preferred orientation, on a (022) X-ray rocking curve measured in a reflection geometry and in a manner that a 2θ axis makes 90° with a rolling direction, is greater than or equal to twice as large as a peak intensity at an incident angle corresponding to (011) preferred orientation on a (022) X-ray rocking curve measured in a reflection geometry and in a manner that a 2θ axis makes 90° with a rolling direction.

An evaluation method of a collector aluminum foil according to the present invention, includes the steps of:

performing XRD measurement on a collector aluminum foil after being cold-rolled; and

evaluating strength of the aluminum foil by at least one of following six values, the values including:

a value of I_{LR}(111)/I_{LR}(002) expressed by I_{LR}(111), denoting an intensity of a (111) diffraction peak in a rolling direction, and I_{LR}(002), denoting an intensity of a (002) diffraction peak in a rolling direction;

a value of I_{LR}(111)/I_{LR}(022) expressed by I_{LR}(111), denoting an intensity of a (111) diffraction peak in a rolling direction, and I_{LR}(022), denoting an intensity of a (022) diffraction peak in a rolling direction;

a value of I_{B}(022)/I_{B}(111) expressed by I_{B}(022), denoting an intensity of a (022) diffraction peak in a direction normal to a rolled surface, and I_{B}(111), denoting an intensity of a (111) diffraction peak;

a value of I_{B}(022)/I_{B}(002) expressed by I_{B}(022), denoting an intensity of a (022) diffraction peak in a direction normal to a rolled surface, and I_{B}(002), denoting an intensity of a (002) diffraction peak in a direction normal to a rolled surface;

a value of I₁/I₀ expressed by I₀, denoting an intensity of, out of two (022) diffraction peaks in a direction normal to a rolled surface, respectively derived from a CuKα1 radiation and a CuKα2 radiation of an incident X-ray, a (022) diffraction peak derived from the CuKα1 radiation, and I₁, denoting an intensity at a valley formed by an overlap of the two (022) diffraction peaks; and

a ratio between a peak intensity, corresponding to (122) or (123) preferred orientation on a (022) X-ray rocking curve measured in a reflection geometry and in a manner that a 2θ axis makes 90° with a rolling direction, and an intensity at an incident angle corresponding to (011) preferred orientation.

### Advantageous Effects of Invention

The present invention provides an aluminum foil with high mechanical strength.

### BRIEF DESCRIPTION OF DRAWINGS

FIG. 1 is a diagram illustrating an XRD spectrum of an aluminum foil A1 according to an exemplary embodiment of the present invention, measured in the reflection geometry, FIG. 1(a) is a diagram illustrating an XRD spectrum on a low-angle region, and FIG. 1(b) is a diagram illustrating an XRD spectrum on a high-angle region.

FIG. 2 is a diagram illustrating an XRD spectrum of an aluminum foil B1 according to the exemplary embodiment of the present invention, measured in the reflection geometry, FIG. 2(a) is a diagram illustrating an XRD spectrum on the low-angle region, and FIG. 2(b) is a diagram illustrating an XRD spectrum on the high-angle region.

FIG. 3 is a diagram illustrating a comparison among measurement samples of an index I_{B}(022)/I_{B}(111) representing (011) preferred orientation in a direction normal to a rolled surface according to the exemplary embodiment of the present invention.

FIG. 4 is a diagram illustrating a comparison among measurement samples of an index I_{B}(022)/I_{B}(002) representing (011) preferred orientation in the direction normal to the rolled surface according to the exemplary embodiment of the present invention.

FIG. 5 is a diagram illustrating (022) rocking curves of the aluminum foils A1 and B1 according to the exemplary embodiment of the present invention, measured in the reflection geometry and in a manner that a 2θ axis makes 90° with a rolling direction.

FIG. 6 is a diagram illustrating (022) rocking curves of aluminum foils A1 to A4 according to the exemplary embodiment of the present invention, measured in the reflection geometry and in a manner that the 2θ axis makes 90° with the rolling direction.

FIG. 7 is a diagram illustrating (022) rocking curves of aluminum foils B1 to B4 according to the exemplary embodiment of the present invention, measured in the reflection geometry and in a manner that the 2θ axis makes 90° with the rolling direction.

FIG. 8 is a diagram illustrating an XRD spectrum of the aluminum foil A1 according to the exemplary embodiment of the present invention, measured in the transmission geometry and in a manner that the 2θ axis makes 90° with the rolling direction, FIG. 8(a) is a diagram illustrating an XRD spectrum on the low-angle region, and FIG. 8(b) is a diagram illustrating an XRD spectrum on the high-angle region.

FIG. 9 is a diagram illustrating an XRD spectrum of the aluminum foil B1 according to the exemplary embodiment of the present invention, measured in the transmission geometry and in a manner that the 2θ axis makes 90° with the rolling direction, FIG. 9(a) is a diagram illustrating an XRD spectrum on the low-angle region, and FIG. 9(b) is a diagram illustrating an XRD spectrum on the high-angle region.

FIG. 10 is a diagram illustrating a comparison among measurement samples of an index I_{LR}(111)/I_{LR}(002) representing (111) preferred orientation in the rolling direction according to the exemplary embodiment of the present invention.

FIG. 11 is a diagram illustrating a comparison among measurement samples of an index I_{LR}(111)/I_{LR}(022) representing (111) preferred orientation in the rolling direction according to the exemplary embodiment of the present invention.

FIG. 12 is an explanatory diagram of resolved shear stress.

FIG. 13 is a diagram illustrating a comparison of calculated values of a Schmidt factor in a slip system of a face-centered cubic lattice.

FIG. 14 is a diagram illustrating comparisons of XRD spectra in the reflection geometry from the aluminum foil B1 according to the exemplary embodiment of the present invention, FIG. 14(a) is a diagram illustrating an XRD spectrum of the aluminum foil B1 before heat treatment, FIG. 14(b) is a diagram illustrating an XRD spectrum of the aluminum foil B1 heat-treated at 150° C., FIG. 14(c) is a diagram illustrating an XRD spectrum of the aluminum foil B1 heat-treated at 200° C., and FIG. 14(d) is a diagram illustrating an XRD spectrum of the aluminum foil B1 heat-treated at 270° C.

FIG. 15 is a diagram illustrating (022) diffraction peaks in high-resolution XRD spectra of the aluminum foil B1 according to the exemplary embodiment of the present invention before heat treatment and heat-treated at respective temperatures.

FIG. 16 is a diagram illustrating heat treatment temperature dependence of a hardness index of the aluminum foil B1 according to the exemplary embodiment of the present invention.

FIG. 17 is a schematic diagram for description of the hardness index.

FIG. 18 is a diagram illustrating heat treatment temperature dependence of the respective hardness indices of the aluminum foils A1 and B1 according to the exemplary embodiment of the present invention.

### DESCRIPTION OF EMBODIMENTS

A collector aluminum foil according to the present invention has one or more of the following characteristics (1) to (7), and preferably all of the characteristics (1) to (7).

(1) A value of I_{B}(022)/I_{B}(011) expressed by I_{B}(022), denoting an intensity of a (022) diffraction peak, and I_{B}(111), denoting an intensity of a (111) diffraction peak, appearing in an X-ray diffraction (XRD) spectrum measured in a reflection geometry, is 200 or smaller.
(2) A value of I_{B}(022)/I_{B}(002) expressed by I_{B}(022), denoting an intensity of a (022) diffraction peak, and I_{B}(002), denoting an intensity of a (002) diffraction peak, appearing in an XRD spectrum measured in the reflection geometry, is 12 or smaller.
(3) A value of I_{LR}(111)/I_{LR}(002) expressed by I_{LR}(111), denoting an intensity of a (111) diffraction peak appearing in an XRD spectrum measured in the transmission geometry and in a manner that a 2θ axis makes 90° with a rolling direction, and I_{LR}(002), denoting an intensity of a (002) diffraction peak, is 35 or greater.
(4) A value of I_{LR}(111)/I_{LR}(022) expressed by I_{LR}(111), denoting an intensity of a (111) diffraction peak appearing in an XRD spectrum measured in the transmission geometry and in a manner that the 2θ axis makes 90° with the rolling direction, and I_{LR}(022), denoting an intensity of a (022) diffraction peak, is 760 or greater.
(5) A value of I₁/I₀ expressed by I₀, denoting an intensity of, out of two (022) diffraction peaks in a direction normal to a rolled surface, respectively derived from a CuKα1 radiation and a CuKα2 radiation of an incident X-ray appearing in an XRD spectrum measured in the reflection geometry, a (022) diffraction peak derived from the CuKα1 radiation, and I₁, denoting an intensity at a valley formed by an overlap of the two (022) diffraction peaks, is 0.22 or greater.
(6) A (022) X-ray rocking curve measured in the reflection geometry and in such a manner that the 2θ axis makes 90° with the rolling direction has a local minimum value at an incident angle of an incident X-ray in a range from 30° to 35°, and has a first local maximum value and a second local maximum value at the incident angles in ranges from 15° to 20° and from 47° to 52°, respectively.
(7) A peak intensity, corresponding to (122) or (123) preferred orientation on a (022) X-ray rocking curve measured in the reflection geometry and in a manner that the 2θ axis makes 90° with the rolling direction, is greater than or equal to twice as large as an intensity at an incident angle corresponding to (011) preferred orientation.

In order to use an aluminum foil as a collector, physical properties of such a foil need to be understood and controlled. Regarding crystal preferred orientation of an aluminum foil and temperature dependence thereof, an aluminum foil having one or more of the aforementioned characteristics (1) to (7), and preferably all of the characteristics (1) to (7), has high mechanical strength and therefore is less liable to break. The XRD measurement will be described in detail in an example.

Such a collector aluminum foil according to the present invention can be manufactured by a common method. In other words, it is known to be feasible to control an internal fine structure of aluminum by subjecting an aluminum ingot to homogenization treatment. Specifically, a crystal grain size, a crystal defect, and the like inside an ingot can be controlled by controlling conditions of homogenization treatment including temperature, time, and a rate of temperature rise/drop.

Next, hot rolling and cold rolling are performed on the homogenization-treated ingot to obtain an aluminum foil with desired thickness, strength, and a crystal grain size. Cold rolling may be performed in combination with annealing for minute control of a crystal grain size after the cold rolling. Foil strength can be controlled by controlling temperature in the hot rolling and a rolling ratio in hot/cold rolling.

As described above, there are many alternatives in a manufacturing process for obtaining the collector aluminum foil according to the present invention. Thus, it is important for the present invention to have one or more of the aforementioned characteristics (1) to (7), and preferably all of the characteristics (1) to (7).

Next, a secondary battery according to the present invention will be described. The secondary battery according to the present invention includes the collector aluminum foil according to the present invention, and is characterized by using an aluminum foil having one or more of the aforementioned characteristics (1) to (7), and preferably all of the characteristics (1) to (7), as an electrode collector.

The secondary battery according to the present invention includes, for example, a positive electrode including a layer containing a positive electrode active material, being formed on a positive electrode collector (the collector aluminum foil according to the present invention), and a negative electrode including a layer containing a negative electrode active material, being formed on a negative electrode collector. The positive electrode and the negative electrode included in the secondary battery according to the present invention are disposed to face each other with a porous separator including an electrolytic solution in between. The porous separator is disposed approximately parallel to the layer containing the negative electrode active material.

A shape of the secondary battery according to the present invention is not particularly limited and may include, for example, a cylindrical type, a square type, a coin type, and a laminated pack.

As for the positive electrode of the secondary battery according to the present invention, in a case of, for example, a lithium ion secondary battery, various materials capable of absorbing, storing/releasing lithium such as a composite oxide including LiₓMO₂ (where M denotes at least one transition metal) may be used. Specifically, as the composite oxide, LiₓCoO₂, LiₓNiO₂, LiₓMn₂O₄, LiₓMnO₃, LiₓNi_{y}Co_{1-y}O₂, and the like, a conductive material such as carbon black, and a binding agent such as polyvinylidene fluoride (PVdF) are dispersed and kneaded with a solvent. N-methyl-2-pyrrolidone (NMP) and the like can be considered as the solvent. For example, an aluminum foil, being the positive electrode collector according to the present invention, coated with the material thus dispersed and kneaded may be used as the positive electrode of the secondary battery according to the present invention.

As for the negative electrode of the secondary battery according to the present invention, in the case of, for example, a lithium ion secondary battery, a base body such as a metallic foil, coated with graphite, a conductive material such as carbon black, and a binding agent such as PVdF dispersed and kneaded with a solvent such as NMP, may be used as the negative electrode material. The base body such as a metallic foil is a negative electrode collector.

The secondary battery according to the present invention may be manufactured in such a manner that the negative electrode and the positive electrode are laminated with a separator in between in dry air or an inert gas atmosphere, or further wound after being laminated, and then housed in a battery can. Alternatively, the secondary battery according to the present invention may be manufactured in such a manner that the negative electrode and the positive electrode are laminated with a separator in between in dry air or an inert gas atmosphere, or further wound after being laminated, and then sealed by a flexible film composed of a laminated body including synthetic resin and a metallic foil, and the like.

As the separator, polyolefin, such as polypropylene and polyethylene, and a porous film such as fluororesin may be suitably used.

As the electrolytic solution according to the present invention, a lithium salt dissolved in one kind of or a mixture of more than one kind of organic solvents including cyclic carbonates such as propylene carbonate (PC), ethylene carbonate (EC), butylene carbonate (BC), and vinylene carbonate (VC), chain carbonates such as dimethyl carbonate (DMC), diethyl carbonate (DEC), ethyl methyl carbonate (EMC), and dipropyl carbonate (DPC), aliphatic carboxylic acid esters such as methyl formate, methyl acetate, and ethyl propionate, γ-lactones such as γ-butyrolactone, chain ethers such as 1,2-ethoxyethane (DEE), and ethoxy-methoxy ethane (EME), cyclic ethers such as tetrahydrofuran and 2-methyltetrahydofuran, and aprotic organic solvents such as dimethyl sulfoxide, 1,3-dioxolane, formamide, acetamide, dimethylformamide, dioxolane, acetonitrile, propylnitrile, nitromethane, ethyl monoglyme, phosphoric triester, trimethoxymethane, a dioxolane derivative, sulfolane, methylsulfolane, 1,3-dimethyl-2-imidazolidinone, 3-methyl-2-oxazolidinone, a propylene carbonate derivative, a tetrahydrofuran derivative, ethyl ether, 1,3-propane sultone, anisole, N-methylpyrrolidone, and fluorinated carboxylic ester may be used. As a lithium salt, LiPF₆, LiAsF₆, LiAlCl₄, LiClO₄, LiBF₄, LiSbF₆, LiCF₃SO₃, LiC₄F₉CO₃, LiC(CF₃SO₂)₂, LiN(CF₃SO₂)₂, LiN(C₂F₅SO₂)₂, LiB₁₀Cl₁₀, lithium lower aliphatic carboxylate, chloroborane lithium, lithium tetraphenylborate, LiBr, LiI, LiSCN, LiCl, and imides can be cited as examples. Further, a polymer electrolyte may be used instead of the electrolytic solution.

The secondary battery according to the present invention may use a known configuration and a known material except that the collector is the collector aluminum foil according to the present invention, and may be manufactured by using a known method.

Next, an evaluation method of the collector aluminum foil according to the present invention will be described. The evaluation method of the collector aluminum foil according to the present invention performs XRD measurements on a collector aluminum foil after being cold-rolled, and is capable of evaluating strength of the aluminum foil by at least one of the following six values (1) to (6).

(1) A value of I_{LR}(111)/I_{LR}(002) expressed by I_{LR}(111), denoting an intensity of a (111) diffraction peak in the rolling direction, and I_{LR}(002), denoting an intensity of a (002) diffraction peak in the rolling direction
(2) A value of I_{LR}(111)/I_{LR}(022) expressed by I_{LR}(111), denoting an intensity of a (111) diffraction peak in the rolling direction, and I_{LR}(022), denoting an intensity of a (022) diffraction peak in the rolling direction
(3) A value of I_{B}(022)/I_{B}(011) expressed by I_{B}(022), denoting an intensity of a (022) diffraction peak in the direction normal to the rolled surface, and I_{B}(111), denoting an intensity of a (111) diffraction peak
(4) A value of I_{B}(022)/I_{B}(002) expressed by I_{B}(022), denoting an intensity of a (022) diffraction peak in the direction normal to the rolled surface, and I_{B}(002), denoting an intensity of a (002) diffraction peak in the direction normal to the rolled surface
(5) A value of I₁/I₀
(6) A ratio between a peak intensity, corresponding to (122) or (123) preferred orientation on a (022) X-ray rocking curve measured in the reflection geometry and in a manner that the 2θ axis makes 90° with the rolling direction, and a peak intensity at an incident angle corresponding to (011) preferred orientation on a (022) X-ray rocking curve measured in a reflection geometry and in a manner that a 2θ axis makes 90° with a rolling direction.

### Example

### XRD Measurements of Aluminum Foils A1 to A4 and B1 to B4

The XRD measurement in the reflection geometry was performed in order to evaluate crystal preferred orientation, in a direction normal to a rolled surface, of collector aluminum foils manufactured by a common method as described above.

Measurement samples include eight kinds of aluminum foils respectively manufactured by different methods (with thickness of 15 μm, respectively). Four of the eight kinds, aluminum foils A1 to A4, do not break even when hot pressing with a peak temperature of 270° C. is applied. However, the remaining four kinds, aluminum foils B1 to B4, are confirmed to break when hot pressing with a maximum temperature of 270° C. is applied.

An X-ray used in the measurement was a CuKα radiation at a wavelength of 0.1542 nm.

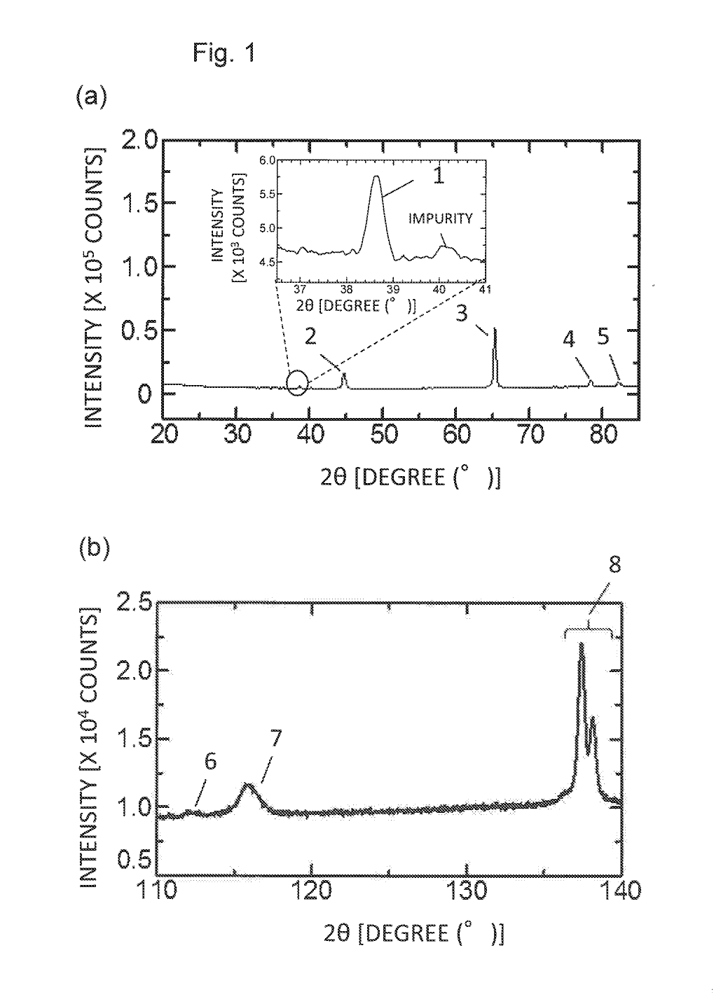

For example, a measurement result of the aluminum foil A1 is illustrated in FIGS. 1(a) and 1(b). FIG. 1(a) is a diagram illustrating an XRD spectrum of the aluminum foil A1 on a low-angle region measured in the reflection geometry. FIG. 1(b) is a diagram illustrating an XRD spectrum of the aluminum foil A1 on a high-angle region measured in the reflection geometry. In FIG. 1(a), an XRD spectrum magnifying the vicinity of a (111) diffraction peak 1 is superimposed on the diagram. The (111) diffraction peak 1, a (002) diffraction peak 2, a (022) diffraction peak 3, a (113) diffraction peak 4, and a (222) diffraction peak 5 are respectively attributed to the (111), (002), (022), (113), (222) planes of a face-centered cubic lattice of aluminum.

As illustrated in FIG. 1(a), the (022) diffraction peak 3 is higher than the other diffraction peaks (such as the (002) diffraction peak 2 and the (113) diffraction peak 4). This indicates that the aluminum foil A1 is (011) oriented in the direction normal to the rolled surface.

It is assumed that I_{B}(022), I_{B}(002), and I_{B}(111) respectively denote intensities of the (022) diffraction peak 3, the (002) diffraction peak 2, and the (111) diffraction peak 1 in the reflection geometry. I_{B}(022)/I_{B}(111) and I_{B}(022)/I_{B}(002) are adopted as indices representing a degree of (011) preferred orientation (hereinafter referred to as orientational indices). In the case of the aluminum foil A1, I_{B}(022)/I_{B}(111)=33.0 and I_{B}(022)/I_{B}(002)=3.91 were obtained.

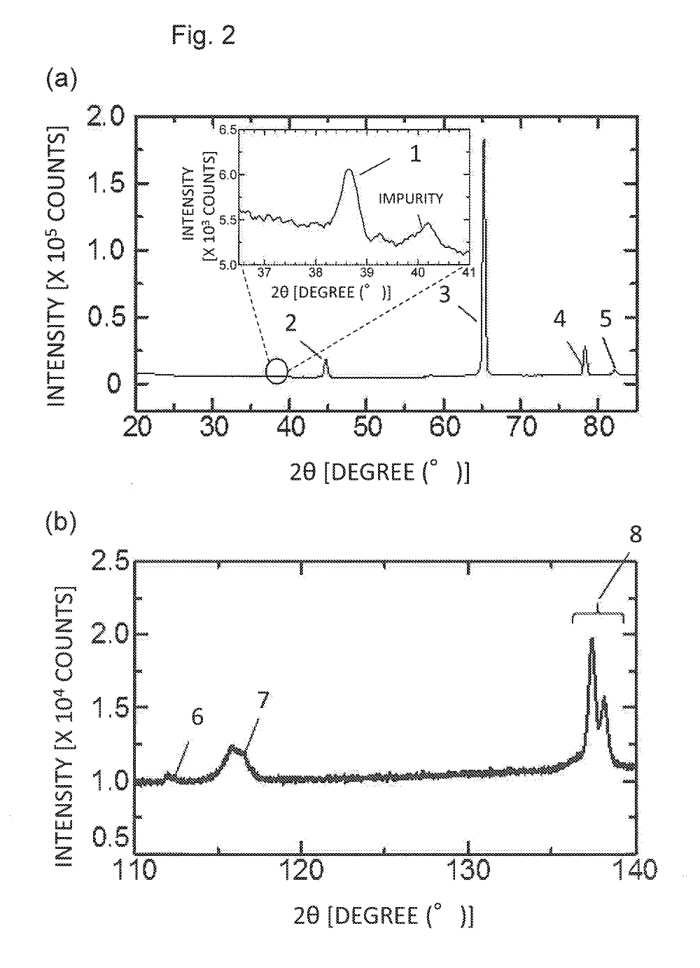

Next, a measurement result of the aluminum foil B1 is illustrated in FIGS. 2(a) and 2(b). FIG. 2(a) is a diagram illustrating an XRD spectrum of the aluminum foil B1 on the low-angle region measured in the reflection geometry. FIG. 2(b) is a diagram illustrating an XRD spectrum of the aluminum foil B1 on the high-angle region measured in the reflection geometry. In FIG. 2(a), an XRD spectrum magnifying the vicinity of a (111) diffraction peak 1 is superimposed on the diagram. Attribution of respective peaks in FIGS. 2(a) and 2(b) is similar to the aluminum foil A1.

As illustrated in FIG. 2(a), a (022) diffraction peak 3 is higher than the other diffraction peaks (such as a (002) diffraction peak 2 and a (113) diffraction peak 4), similarly to FIG. 1(a). This indicates that the aluminum foil B1 is also (011) oriented in the direction normal to the rolled surface.

Determining orientational indices similarly to the aluminum foil A1, I_{B}(022)/I_{B}(111)=203 and I_{B}(022)/I_{B}(002)=13.8 were obtained in the case of the aluminum foil B1.

Compared with the aluminum foil A1, the aluminum foil B1 exhibits larger values for both I_{B}(022)/I_{B}(111) and I_{B}(022)/I_{B}(002). This indicates that the aluminum foil B1 has higher (011) preferred orientation in the direction normal to the rolled surface than the aluminum foil A1. Specifically, this means that the aluminum foil B1 contains more crystal grains (011) oriented in the direction normal to the rolled surface, or that the aluminum foil B1 contains (011) oriented crystal grains with larger crystal grain sizes. A larger crystal grain size means a wider range of movement by a slip of dislocation within the grain. Further, the slip of the dislocation is a cause of breaking of a metallic foil. Thus, it is estimated that one reason for the aluminum foil B1 breaking by hot pressing with a maximum temperature of 270° C. is a large crystal grain size.

Looking at the spectra on the high-angle region (FIGS. 1(b) and 2(b)), a (133) diffraction peak 6, a (024) diffraction peak 7, and a (224) diffraction peak 8 are observed. While the (224) diffraction peak 8 has a large value, difference in peak intensity between the measurement samples is small.

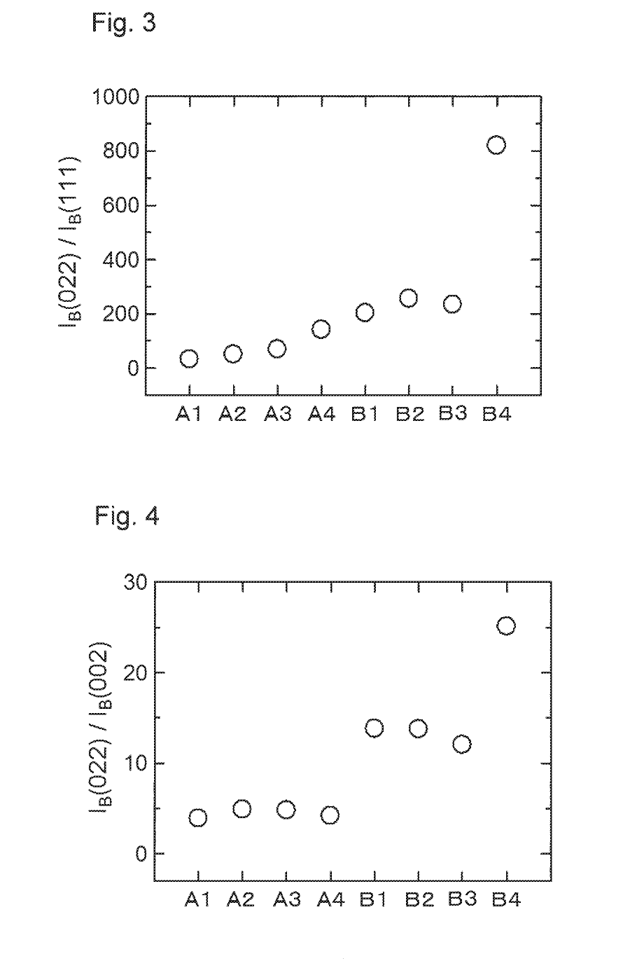

FIGS. 3 and 4 are diagrams respectively illustrating comparisons among measurement samples of orientational indices measured in the reflection geometry. FIG. 3 illustrates I_{B}(022)/I_{B}(111) and FIG. 4 illustrates I_{B}(022)/I_{B}(002). Measurement results of the aluminum foils

A2 to A4 and B2 to B4 are also illustrated in addition to the aforementioned aluminum foils A1 and B1. As illustrated in FIG. 3, the minimum value of I_{B}(022)/I_{B}(111) for the aluminum foils B1 to B4 that break by hot pressing with a maximum temperature of 270° C. is 203, and the maximum value of I_{B}(022)/I_{B}(111) for the aluminum foils A1 to A4 that do not break is 142. A threshold value determining break or no-break exists between these values. Therefore, the present exemplary embodiment sets the threshold value to 200. It is more preferable to set the value to 140 or smaller.

Similarly, as illustrated in FIG. 4, a threshold value determined for I_{B}(022)/I_{B}(002) is in a range from 4.89 to 12.1. Therefore, the present exemplary embodiment sets the threshold value to 12.0 or smaller. It is more preferable to set the value to 10.0 or smaller, or 5.00 or smaller.

The measurement results described above suggest that both the aluminum foils A1 and B1 have crystal grains with (001), (111), (112), (133), (012), and (011) preferred orientation, and that the aluminum foil B1 has higher (011) preferred orientation.

Next, the rocking curve measurement was performed to examine orientation in the direction normal to the rolled surface other than the orientation described above. A sample aluminum foil was arranged in a manner that a 2θ axis makes 90° with a rolling direction. The 2θ axis refers to a scan axis of an X-ray detector or an incident angle of an incident X-ray. An incident angle ω of an incident X-ray into the sample aluminum foil was swept and a rocking curve was measured in the reflection geometry.

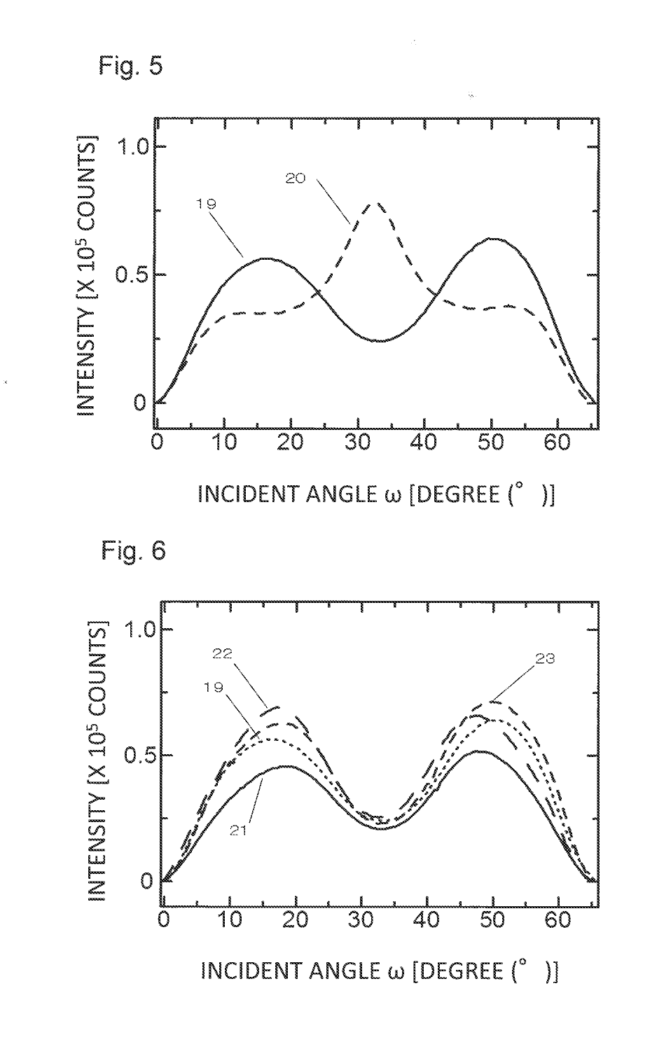

FIG. 5 is a diagram illustrating (022) rocking curves of the aluminum foils A1 and B1, respectively. A rocking curve 19 of the aluminum foil A1 has a local minimum value at around ω=32.58° (denoted as θ_{B}) and is in line symmetric about ω=θ₁₃. In particular, there are local maximum values at around ω=15.50° and 50.50°, respectively. These local maximum values indicate that (122) or (123) oriented crystal grains exist in the aluminum foil A1.

In contrast with the aluminum foil A1, a rocking curve 20 of the aluminum foil B1 has a local maximum value at ω=θ_{B} and does not have any remarkable local maximum value other than at around ω=θ_{B}. The shape of the rocking curve indicates that the aluminum foil B1 has a less number of (122) or (123) oriented crystal grains than the aluminum foil A1. From these results, one cause for low (011) preferred orientation of the aluminum foil A1 is estimated to be higher (122), (123) preferred orientation than the aluminum foil B1.

FIG. 6 illustrates (022) rocking curves of the aluminum foils A1 to A4 measured under the condition similar to that of FIG. 5. FIG. 6 illustrates a rocking curve 19 of the aluminum foil A1, a rocking curve 21 of the aluminum foil A2, a rocking curve 22 of the aluminum foil A3, and a rocking curve 23 of the aluminum foil A4.

Every rocking curve has a local minimum value at around ω=θ_{B} (in a range from ω=32.50° to 33.50°) and has local maximum values in respective ranges from ω=16.00° to 19.00° and from 47.50° to 50.50°. In other words, the (022) rocking curve having a shape illustrated in FIG. 6 is a common characteristic throughout the foils A1 to A4, being less liable to break. That is to say, each of the aluminum foils A1 to A4, being less liable to break, has high (122) or (123) preferred orientation.

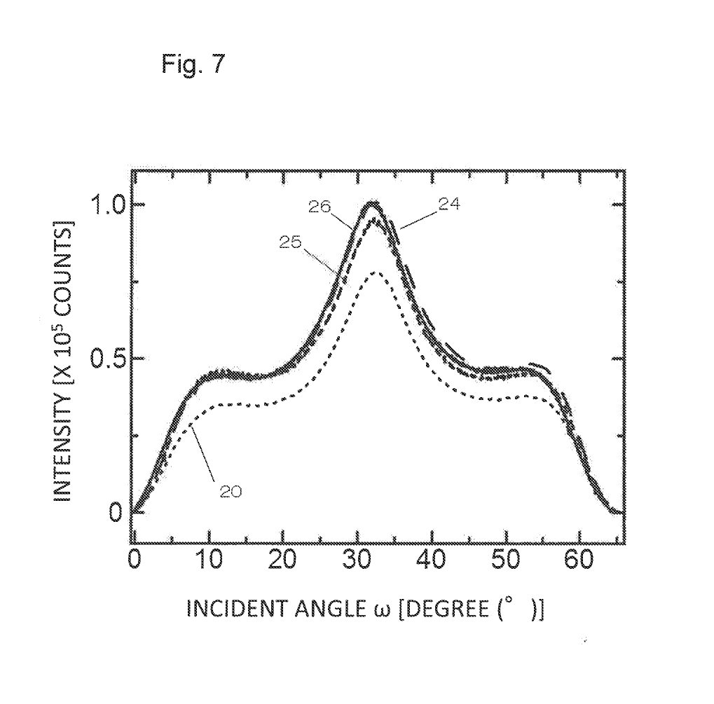

FIG. 7 illustrates (022) rocking curves of the aluminum foils B1 to B4 measured under the same condition as FIGS. 5 and 6. FIG. 7 illustrates a rocking curve 20 of the aluminum foil B1, a rocking curve 24 of the aluminum foil B2, a rocking curve 25 of the aluminum foil B3, and a rocking curve 26 of the aluminum foil B4.

While absolute values of intensities differ among the aluminum foils B1 to B4, every rocking curve has a local maximum value at around ω=θ_{B}, and is in line symmetric about ω giving the local maximum value. Consequently, it is suggested that each of the aluminum foils B1 to B4 has high (011) preferred orientation.

Thus, it is conceivable that use of an aluminum foil having a (022) rocking curve with a shape illustrated in FIG. 6 is effective in preventing breaking caused by heat treatment.

The following is understood from the (022) X-ray rocking curves in FIG. 6 measured in the reflection geometry in such a manner that the 2θ axis makes 90° with the rolling direction. That is, it is preferable to use an aluminum foil having a local minimum value at an incident angle of an incident X-ray in a range from 30° to 35°, and having a first local maximum value and a second local maximum value at incident angles in ranges from 15° to 20° and from 47° to 52°, respectively.

Further, it is more preferable to use an aluminum foil having a first local maximum value at an incident angle in a range from 16.0° to 19.0° and a second local maximum value at an incident angle in a range from 47.5° to 50.5°. Further, it is more preferable to use an aluminum foil having a local minimum value at an incident angle in a range from 32.5° to 33.5°.

Furthermore, FIG. 6 suggests that each of the local maximum values corresponding to (122) or (123) preferred orientation in the rocking curves 19, 21, 22, and 23 of the aluminum foils A1 to A4, respectively, has a value approximately 2.3 to 2.8 times as large as the local minimum value on the same curve. Therefore, the present exemplary embodiment sets a threshold value as follows. That is, it is preferable to use a collector aluminum foil having a peak intensity corresponding to (122) or (123) preferred orientation being at least twice as large as an intensity at an incident angle corresponding to (011) preferred orientation.

Next, the XRD measurement in the transmission geometry was performed in order to evaluate crystal preferred orientation in the rolling direction.

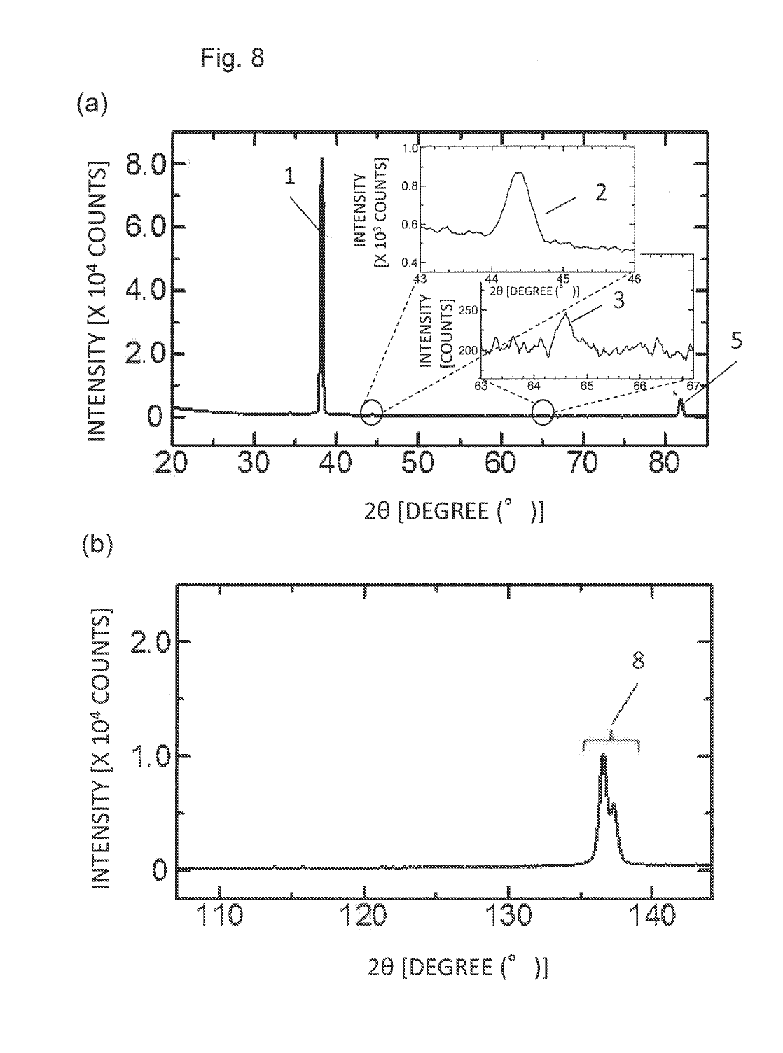

FIGS. 8(a) and 8(b) illustrate XRD spectra of the aluminum foil A1 measured in the transmission geometry and in a manner that the 2θ axis makes 90° with the rolling direction. FIG. 8(a) is a diagram illustrating an XRD spectrum on a low-angle region and FIG. 8(b) is a diagram illustrating an XRD spectrum on a high-angle region. In FIG. 8(a), XRD spectra partially magnifying the respective vicinities of a (002) diffraction peak 2 and a (022) diffraction peak 3 are superimposed on the diagram. Measurement in this geometry clarifies orientation in the rolling direction. The orientation in the rolling direction represents strength of a collector aluminum foil against tension in the rolling direction. While the (022) diffraction peak is a main component in measurement in the reflection geometry (FIGS. 1(a) and 2(a)), a (111) diffraction peak 1 and a (222) diffraction peak 5 are dominant in FIG. 8(a) which is a measurement result in the transmission geometry. Other diffraction peaks are low. Therefore, the aluminum foil A1 is mainly (111) oriented in the rolling direction.

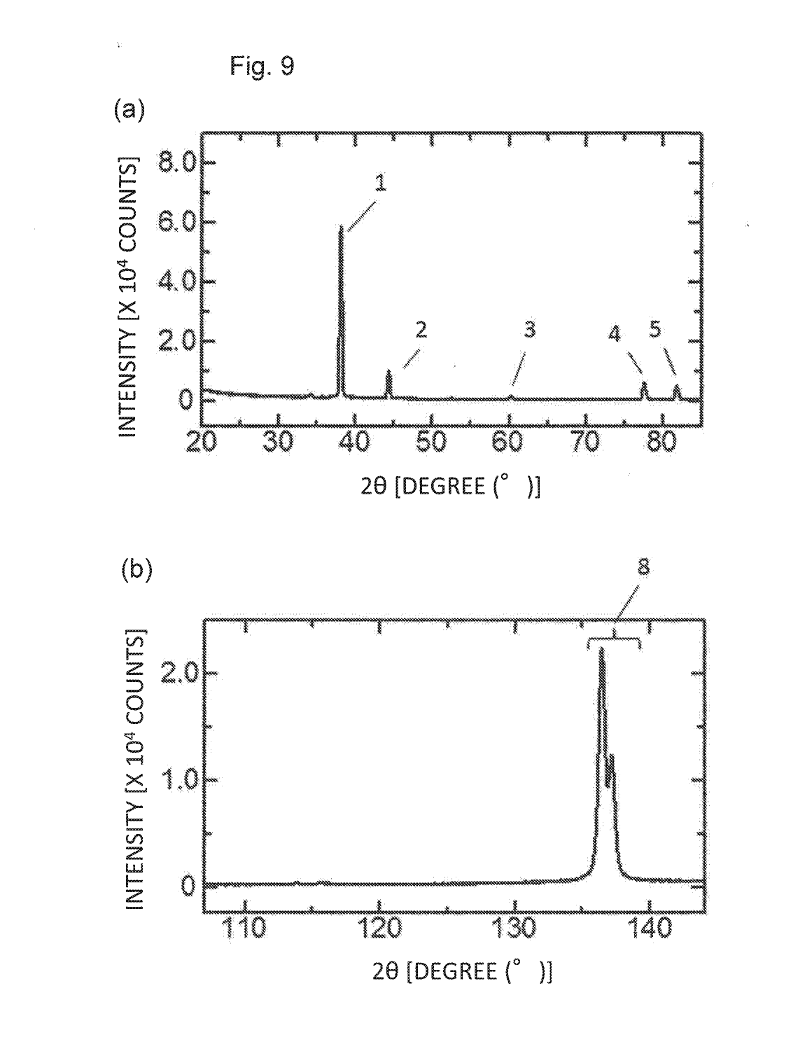

FIGS. 9(a) and 9(b) illustrate similar measurement results with respect to the aluminum foil B1. The figures are diagrams illustrating XRD spectra of the aluminum foil B1 measured in the transmission geometry and in a manner that the 2θ axis makes 90° with the rolling direction, and FIG. 9(a) is a diagram illustrating an XRD spectrum on the low-angle region and FIG. 9(b) is a diagram illustrating an XRD spectrum on the high-angle region. Similarly to FIG. 8(a), a (111) diffraction peak 1 is dominant in FIG. 9(a), however, other diffraction peaks are observed at levels of a comparable order of magnitude as well, compared with the aluminum foil A1. The aluminum foil B1 also has high (111) preferred orientation in the rolling direction but with a smaller degree compared with the aluminum foil A1.

It is assumed that intensities of a (111) diffraction peak 1, (002) diffraction peak 2, and (022) diffraction peak 3 are respectively denoted as I_{LR}(111), I_{LR}(002), and I_{LR}(022). Further, I_{LR}(111)/I_{LR}(002) and I_{LR}(111)/I_{LR}(022) are adopted as orientational indices of (111) preferred orientation in the rolling direction. Consequently, in the case of the aluminum foil A1, I_{LR}(111)/I_{LR}(002)=191 and I_{LR}(111)/I_{LR}(022)=1140 are obtained. Similarly, in the case of the aluminum foil B1, I_{LR}(111)/I_{LR}(002)=6.37 and I_{LR}(111)/I_{LR}(022)=759 are obtained.

Comparing the spectra on the high-angle region (FIGS. 8(b) and 9(b)) between the aluminum foils A1 and B1, a difference in the intensity of the (224) diffraction peak 8 is observed with the aluminum foil B1 having a higher value. It is suggested that the aluminum foil B1 contains more crystal grains orienting the (112) plane in the rolling direction than the aluminum foil A1.

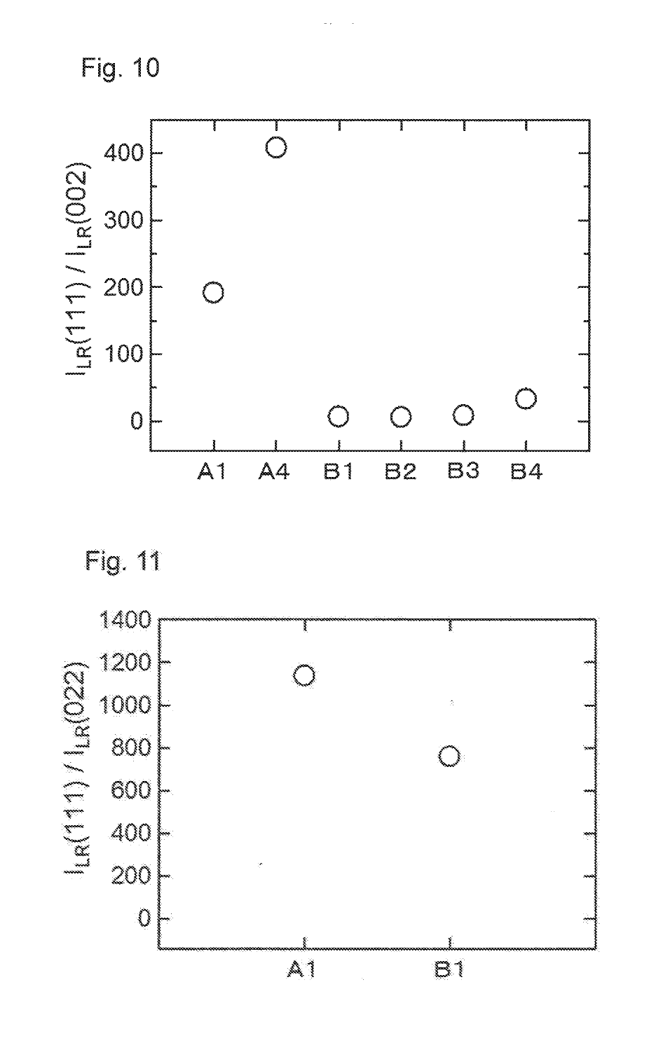

The orientational indices in the rolling direction obtained by the aforementioned measurement in the transmission geometry are illustrated in FIGS. 10 and 11. The values of the aluminum foils A1 to A4 and B1 to B4 are also added as appropriate. FIG. 10 illustrates I_{LR}(111)/I_{LR}(002) and FIG. 11 illustrates I_{LR}(111)/I_{LR}(022). FIG. 10 indicates that the maximum value of I_{LR}(111)/I_{LR}(002) of the aluminum foils B1 to B4 that break by hot pressing with a maximum temperature of 270° C. is 32.9, and the minimum value of I_{LR}(111)/I_{LR}(002) of the aluminum foils A1 to A4 that do not break is 191. Therefore, the present exemplary embodiment sets the value to 35.0 or greater to avoid breaking. It is more preferable to set the value to 190 or greater.

Further, FIG. 11 indicates that the value of I_{LR}(111)/I_{LR}(022) of the aluminum foil B1 that breaks by hot pressing with a maximum temperature of 270° C. is 759, and the value of I_{LR}(111)/I_{LR}(022) of the aluminum foil A1 that does not break is 1140. Therefore, the present exemplary embodiment sets the value to 760 or greater to avoid breaking. It is more preferable to set the value to 1100 or greater. The aluminum foil Ai (where i=1 to 4) has higher (111) preferred orientation in the rolling direction than the aluminum foil Bi (where i=1 to 4). Considering the result along with the aforementioned characteristic of the XRD spectra on the high-angle region, orientation of the aluminum foils in the rolling direction can be summarized as below.

As for orientation in the rolling direction, (111) preferred orientation is dominant in the aluminum foil Ai (where i=1 to 4), and (001), (113), and (112) oriented crystal grains are contained in addition to (111) oriented grains in the aluminum foil Bi (where i=1 to 4).

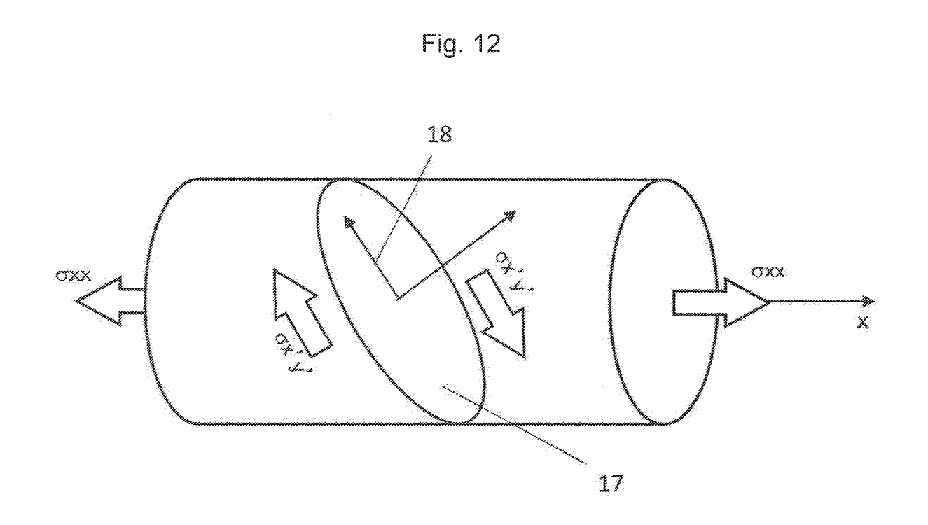

In order to associate the evaluation result of orientation in the rolling direction described above with strength of an aluminum foil, the relationship of the breaking of a foil to the crystal preferred orientation and the dislocation movement will be discussed. In general, a driving force of dislocation in a crystal is shear stress acting in a slip direction. The shear stress can be calculated once a direction of the stress and a slip system are specified. Describing by use of FIG. 12, when a normal stress σₓₓ is applied to a crystal including a slip plane of dislocation (hkl) 17 and a slip direction of dislocation [uvw] 18 along the x axis, a shear stress (resolved shear stress) σ_{x′y′} being a driving force of dislocation is calculated by the following (Equation 1).

σ_{x′y′}=cos α cos βσₓₓ=mσₓₓ (Equation 1)

In this equation, α denotes an angle between the x axis and the slip direction, and β denotes an angle between the x axis and a normal to the slip plane. The factor m representing a magnitude of an effect of the normal stress σₓₓ on the shear stress σ_{x′y′} is referred to as a Schmidt factor. The Schmidt factor m is expressed by m=cos α cos β. The greater the value is, the higher mobility of dislocation becomes. Therefore, it is conceivable that the crystal is liable to deformation and break when crystal preferred orientation with a large value of m is subjected to normal stress.

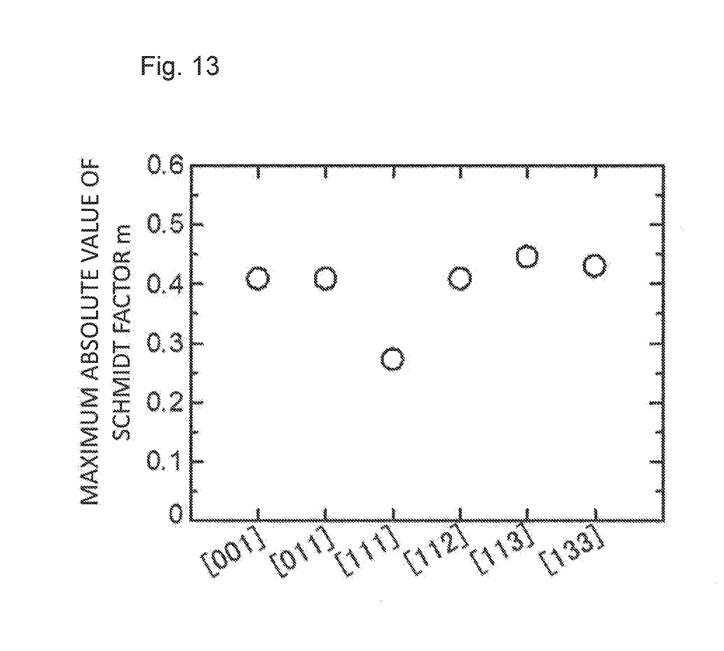

An aluminum crystal forms a face-centered cubic lattice, and therefore a slip system of perfect dislocation is {111}<011>. There are 12 independent slip systems. FIG. 13 illustrates a comparison of maximum absolute values of Schmidt factors calculated for several typical crystal preferred orientations subjected to normal stress. The Schmidt factor in a case that normal stress is applied in the [111] direction exhibits the smallest value while the values for the other orientations mostly range from 0.40 to 0.45. When an equal amount of normal stress is applied, an effect on dislocation movement is minimum when the stress is applied in the [111] direction.

Taking advantage of the discussion described above, strengths of the aluminum foils Ai and Bi (where i=1 to 4) against breaking can be considered as follows. The aluminum foil Ai has high (111) preferred orientation in the rolling direction, and therefore dislocation is not mobile against normal stress in the rolling direction, consequently the aluminum foil Ai is not liable to break. By contrast, the aluminum foil Bi contains (001), (113), and (112) oriented crystal grains with relatively large Schmidt factors in addition to (111) oriented grains. Thus, it is estimated that dislocation is more mobile against normal stress in the rolling direction in the aluminum foil Bi than in the aluminum foil Ai, making the aluminum foil Bi more liable to break.

The above discussion suggests that low (011) preferred orientation in the direction normal to the rolled surface and high (111) preferred orientation in the rolling direction makes the aluminum foil Ai (where i=1 to 4) less liable to break.

Next, the XRD measurement was performed on the aluminum foils A1 to A4 and B1 to B4 after heat-treatment in order to compare crystallinity behavior against heat treatment.

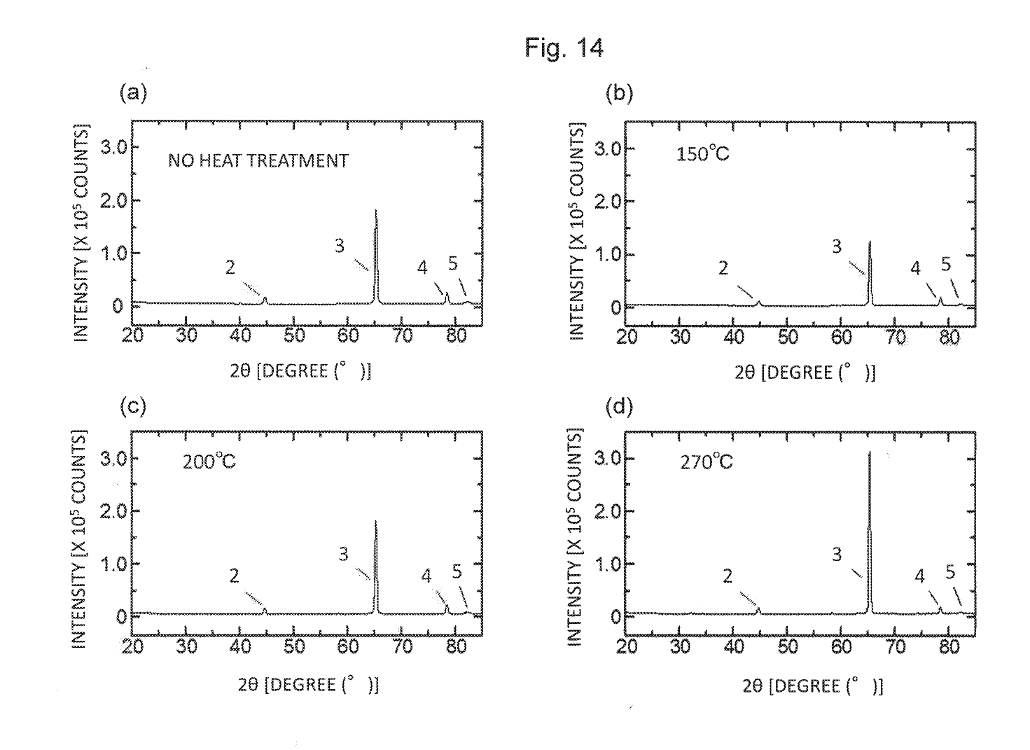

FIGS. 14(a) to 14(d) are diagrams illustrating comparisons of XRD spectra of the aluminum foil B1 according to the exemplary embodiment of the present invention in the reflection geometry. FIG. 14(a) is a diagram illustrating an XRD spectrum of the aluminum foil B1 before heat treatment. FIG. 14(b) is a diagram illustrating an XRD spectrum of the aluminum foil B1 heat-treated at 150° C. FIG. 14(c) is a diagram illustrating an XRD spectrum of the aluminum foil B1 heat-treated at 200° C. FIG. 14(d) is a diagram illustrating an XRD spectrum of the aluminum foil B1 heat-treated at 270° C. There is no significant difference observed between the three cases of no heat treatment (FIG. 14(a)), 150° C. (FIG. 14(b)), and 200° C. (FIG. 14(c)). However, the case of 270° C. (FIG. 14(d)) exhibits a higher intensity of a (022) diffraction peak 3 (approximately 1.5 times higher) than the other three cases. This means that (011) preferred orientation of the aluminum foil was increased by the heat treatment at 270° C.

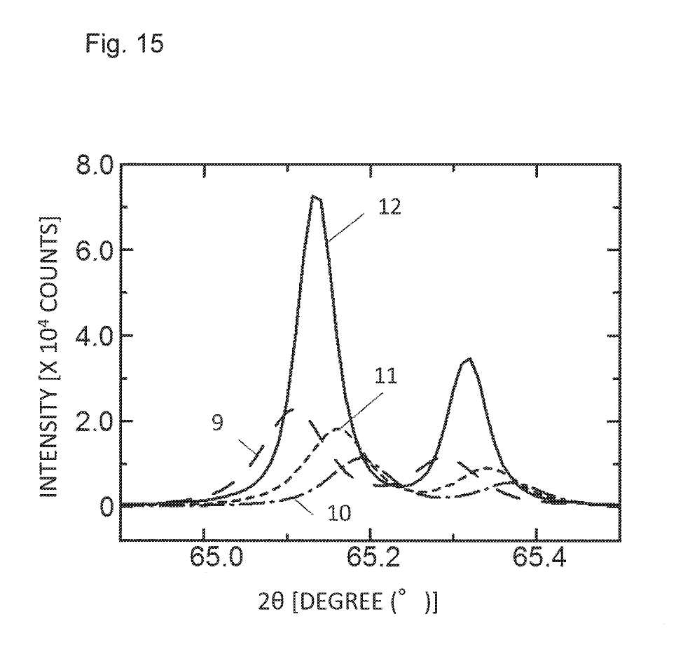

The (022) diffraction peak 3 exhibiting a significant change in diffraction peak value caused by heat treatment was measured with enhanced angular resolution, and the result is illustrated in FIG. 15.

Similarly to the observation in FIGS. 14(a) to 14(d), an intensity of a (022) diffraction peak 12 after 270° C. heat treatment has a high value. Also similarly to the observation in FIGS. 14(a) to 14(d), there is no significant difference observed between the following three peaks, peak intensities of a (022) diffraction peak 9 before heat treatment, a (022) diffraction peak 10 after 150° C. heat treatment, and a (022) diffraction peak 11 after 200° C. heat treatment. Furthermore, locations of peaks differ between peaks with different heat treatment temperatures, implying difference in (022) lattice spacing.

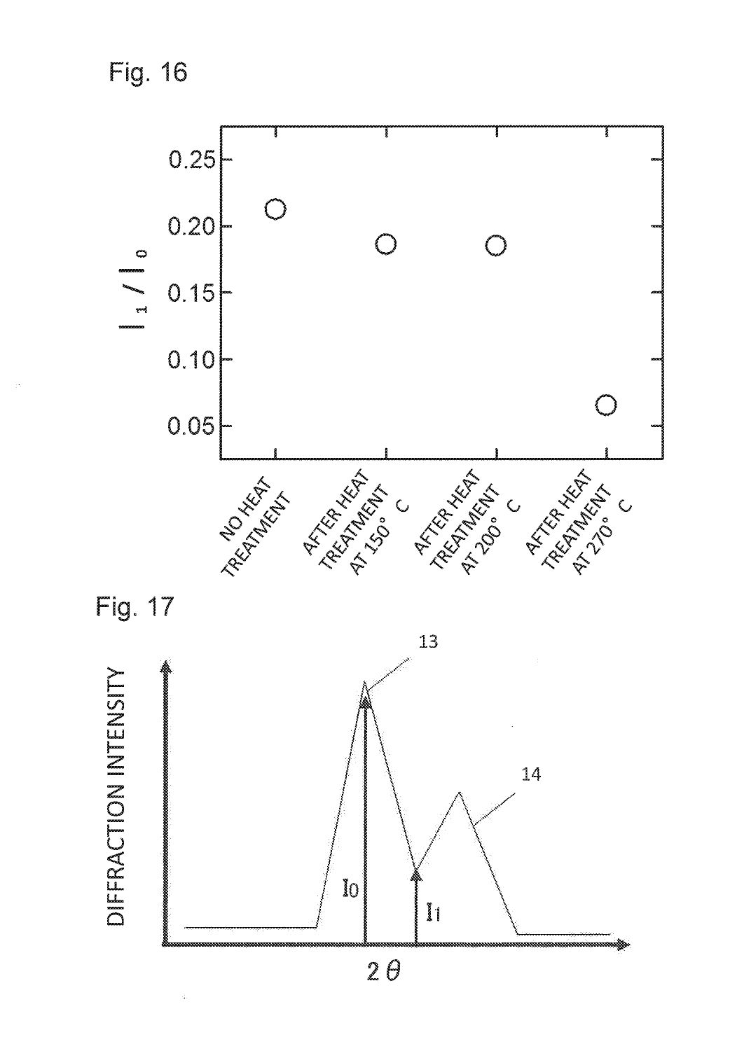

A comparison of a so-called hardness index is illustrated in FIG. 16. A higher hardness index value means that a crystal analyzed has higher hardness, thus being less liable to break as a foil. The hardness index will be described below. In general, a diffraction peak width is determined by a crystallite size and a magnitude of a nonuniform strain (caused by a crystal defect and the like) within the crystal. The diffraction peak width becomes wider as the crystallite size becomes smaller or the nonuniform strain becomes larger. Considering from a viewpoint of dislocation movement, a small crystallite size and a large nonuniform strain both act in a direction preventing dislocation movement. Prevention of dislocation movement suppresses deformation of the crystal and breaking of the foil resulting from the deformation. Thus, it is conceivable that a diffraction peak width indirectly reflects hardness of a foil. An index enabling easy evaluation of the diffraction peak width is the hardness index.

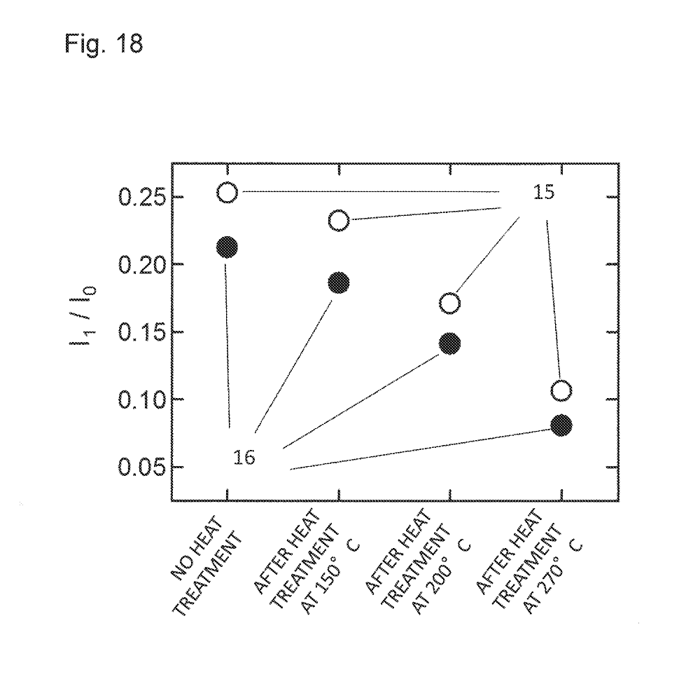

As illustrated in a schematic diagram in FIG. 17, the (022) diffraction peak 3 in FIG. 15 is separated into two peaks (a peak 13 derived from a CuKα1 radiation and a peak 14 derived from a CuKα2 radiation) by measuring with high angular resolution. The reason is that the CuKα radiation in an incident X-ray contains the CuKα1 radiation and the CuKα2 radiation having slightly different energies. A separation width of the two peaks solely depends on the energy difference between the CuKα1 radiation and the CuKα2 radiation. As described above, when a width of two diffraction peaks becomes wider due to change in crystalline hardness, an overlap of the two peaks becomes larger, and an intensity at a valley denoted by I₁ becomes higher. Conversely, when the width of the two diffraction peaks becomes narrower, the overlap of the two peaks becomes smaller and I₁ becomes lower. Therefore, the diffraction peak width can be evaluated by a magnitude of I₁. I₁/I₀ obtained by normalizing I₁ by I₀, denoting an intensity of a diffraction peak by a CuKα1 characteristic ray, is the hardness index, enabling comparison between samples.

Looking at FIG. 16, while hardness indices in the respective cases of no heat treatment, after heat treatment at 150° C., and after heat treatment at 200° C. are around 0.2, the index decreases to 6.44×10−2 in the case of after heat treatment at 270° C. It can be seen that the aluminum foil after 270° C. heat treatment is softer than the other 3 foils heat-treated at different temperatures. The softening by heat treatment is estimated to be caused by work hardening by cold rolling being relaxed by a recrystallization process resulting from heat treatment.

A similar XRD measurement was performed on the aluminum foil A1 that does not cause breaking even when heat treatment at 270° C. is applied, and hardness indices of the foil A1 were compared with the aluminum foil B1 that underwent the same heat treatment as the foil A1. FIG. 18 illustrates a result. The reason hardness index values 16 of the aluminum foil B1 are different from the values in FIG. 16 is difference in heat treatment methods. Hardness indices 15 of the aluminum foil A1 and the hardness indices 16 of the aluminum foil B1 both exhibit lower values as the heat treatment temperature becomes higher. However, it can be seen that the hardness index 15 of the aluminum foil A1 is always higher than the hardness index 16 of the aluminum foil B1 when compared at a same heat treatment temperature, and the aluminum foil A1 is “harder.” Comparing the hardness indices in the case of no heat treatment, the aluminum foil A1 has a value of 0.253 and the aluminum foil B1 has a value of 0.212.

The “hardness” based on the crystallite size and the nonuniform strain within a crystal is one factor determining hot pressing tolerance. It is conceivable from the above discussion that use of an aluminum foil with a large hardness index is effective in preventing breaking caused by hot pressing.

The results described above suggest that use of a collector aluminum foil having at least one or more of the following characteristics (1) to (7), and preferably all of the characteristics (1) to (7), enables to provide a collector aluminum foil less liable to break.

(1) A value of I_{B}(022)/I_{B}(011) expressed by I_{B}(022) denoting an intensity of a (022) diffraction peak and I_{B}(111) denoting an intensity of a (111) diffraction peak, appearing in an X-ray diffraction (XRD) spectrum measured in the reflection geometry, is 200 or smaller.
(2) A value of I_{B}(022)/I_{B}(002) expressed by I_{B}(022) denoting an intensity of a (022) diffraction peak and I_{B}(002) denoting an intensity of a (002) diffraction peak, appearing in an XRD spectrum measured in the reflection geometry, is 12 or smaller.
(3) A value of I_{LR}(111)/I_{LR}(002) expressed by I_{LR}(111), denoting an intensity of a (111) diffraction peak, appearing in an XRD spectrum measured in the transmission geometry and in a manner that the 2θ axis makes 90° with the rolling direction, and I_{LR}(002), denoting an intensity of a (002) diffraction peak, is 35 or greater.
(4) A value of I_{LR}(111)/I_{LR}(022) expressed by I_{LR}(111), denoting an intensity of a (111) diffraction peak, appearing in an XRD spectrum measured in the transmission geometry and in a manner that the 2θ axis makes 90° with the rolling direction, and I_{LR}(022), denoting an intensity of a (022) diffraction peak, is 760 or greater.
(5) In a fifth collector aluminum foil according to the present invention, a value of I₁/I₀ expressed by I₀, denoting an intensity of, out of two (022) diffraction peaks in the direction normal to the rolled surface, respectively derived from a CuKα1 radiation and a CuKα2 radiation of an incident X-ray appearing in an XRD spectrum measured in the reflection geometry, a (022) diffraction peak derived from the CuKα1 radiation, and I₁, denoting an intensity at a valley formed by an overlap of the two (022) diffraction peaks, is 0.22 or greater.
(6) A (022) X-ray rocking curve measured in the reflection geometry and in a manner that the 2θ axis makes 90° with the rolling direction has a local minimum value at an incident angle of an incident X-ray in a range from 30° to 35°, and has a first local maximum value and a second local maximum value at the incident angles in ranges from 15° to 20° and from 47° to 52°, respectively.
(7) A peak intensity, corresponding to (122) or (123) preferred orientation on a (022) X-ray rocking curve measured in the reflection geometry and in a manner that the 2θ axis makes 90° with the rolling direction, is greater than or equal to twice as large as a peak intensity at an incident angle corresponding to (011) preferred orientation on a (022) X-ray rocking curve measured in a reflection geometry and in a manner that a 2θ axis makes 90° with a rolling direction.

Further, application of the collector aluminum foil according to the present invention to a lithium ion secondary battery provides enhancement of long-term reliability. It is known that an active material expands and shrinks accompanying charge and discharge operations in a lithium ion secondary battery in which an aluminum foil is used as a collector. Accordingly, the collector foil is subjected to tensile and compressive forces in an in-plane direction of an electrode sheet plane. The forces become a mechanical load on the collector foil. An increased number of charge and discharge cycles causes such mechanical loads to accumulate and an electrode may break (fatigue breaking). Thus, enhanced mechanical strength of a collector foil is desirable from a viewpoint of securing long-term reliability of a battery as well. Therefore, application of the secondary battery according to the present invention to a lithium ion secondary battery enables to provide improved long-term reliability of the battery due to enhanced mechanical strength of the collector aluminum foil.

Furthermore, use of the evaluation method of a collector aluminum foil according to the present invention enables to provide enhanced productivity of an electrode and a secondary battery.

The preferred exemplary embodiment of the present invention has been described above, however, the present invention is not limited to the aforementioned exemplary embodiment. It goes without saying that various modifications may be made within the scope of the invention described in claims and such modifications are also included in the scope of the present invention.

The aforementioned exemplary embodiments and examples may also be described in whole or part as the following Supplementary Notes but are not limited thereto.

### [Supplementary Note 1]

A collector aluminum foil having a value of I_{B}(022)/I_{B}(111) being 200 or smaller, I_{B}(022) and I_{B}(111) being intensity of (022) diffraction peak and intensity of (111) diffraction peak observed in an XRD spectrum measured in a reflection geometry, respectively.

### [Supplementary Note 2]

The collector aluminum foil according to Supplementary Note 1, wherein the value of I_{B}(022)/I_{B}(111) is 140 or smaller.

### [Supplementary Note 3]

The collector aluminum foil according to Supplementary Note 1 or 2, wherein a value of I_{B}(022)/I_{B}(002) is 12 or smaller, the I_{B}(022) and I_{B}(002) being intensity of (022) diffraction peak and intensity of (002) diffraction peak observed in an XRD spectrum measured in a reflection geometry, respectively.

### [Supplementary Note 4]

The collector aluminum foil according to Supplementary Note 3, wherein the value of I_{B}(022)/I_{B}(002) is 10 or smaller.

### [Supplementary Note 5]

The collector aluminum foil according to Supplementary Note 4, wherein the value of I_{B}(022)/I_{B}(002) is 5 or smaller.

### [Supplementary Note 6]

A collector aluminum foil wherein a value of I_{B}(022)/I_{B}(002) is 12 or smaller, the I_{B}(022) and I_{B}(002) being intensity of (022) diffraction peak and intensity of (002) diffraction peak observed in an XRD spectrum measured in a reflection geometry, respectively.

### [Supplementary Note 7]

The collector aluminum foil according to Supplementary Note 6, wherein the value of I_{B}(022)/I_{B}(002) is 10 or smaller.

### [Supplementary Note 8]

The collector aluminum foil according to Supplementary Note 7, wherein the value of I_{B}(022)/I_{B}(002) is 5 or smaller.

### [Supplementary Note 9]

The collector aluminum foil according to any one of Supplementary Notes 6 to 8, wherein a value of I_{B}(022)/I_{B}(111) is 200 or smaller, I_{B}(022) and I_{B}(111) being intensity of (022) diffraction peak and intensity of (111) diffraction peak observed in an XRD spectrum measured in a reflection geometry, respectively.

### [Supplementary Note 10]

The collector aluminum foil according to Supplementary Note 9, wherein the value of I_{B}(022)/I_{B}(111) is 140 or smaller.

### [Supplementary Note 11]

A collector aluminum foil wherein a value of I_{LR}(111)/I_{LR}(002) is 35 or greater, I_{LR}(111) and I_{LR}(002) being intensity of (111) diffraction peak and intensity of (002) diffraction peak observed in an XRD spectrum measured in a transmission geometry and in a manner that a 2θ axis makes 90° with a rolling direction, respectively.

### [Supplementary Note 12]

The collector aluminum foil according to Supplementary Note 11, wherein a value of I_{LR}(111)/I_{LR}(002) is 190 or greater, I_{LR}(111) and I_{LR}(002) being intensity of (111) diffraction peak and intensity of (002) diffraction peak observed in an XRD spectrum measured in a transmission geometry and in a manner that a 2θ axis makes 90° with a rolling direction, respectively.

### [Supplementary Note 13]

The collector aluminum foil according to Supplementary Note 11 or 12, wherein a value of I_{LR}(111)/I_{LR}(022) is 760 or greater, the I_{LR}(111) and I_{LR}(022) being intensity of (111) diffraction peak and intensity of (022) diffraction peak observed in an XRD spectrum measured in a transmission geometry and in a manner that a 2θ axis makes 90° with a rolling direction, respectively.

### [Supplementary Note 14]

The collector aluminum foil according to Supplementary Note 13, wherein a value of I_{LR}(111)/I_{LR}(022) is 1100 or greater, the I_{LR}(111) and I_{LR}(022) being intensity of (111) diffraction peak and intensity of (022) diffraction peak observed in an XRD spectrum measured in a transmission geometry and in a manner that a 2θ axis makes 90° with a rolling direction, respectively.

### [Supplementary Note 15]

A collector aluminum foil having a value of I_{LR}(111)/I_{LR}(022) being 760 or greater, the I_{LR}(111) and I_{LR}(002) being intensity of (111) diffraction peak and intensity of (002) diffraction peak observed in an XRD spectrum measured in a transmission geometry and in a manner that a 2θ axis makes 90° with a rolling direction, respectively.

### [Supplementary Note 16]

The collector aluminum foil according to Supplementary Note 15, wherein a value of I_{LR}(111)/I_{LR}(022) is 1100 or greater, the I_{LR}(111) and I_{LR}(022) being intensity of (111) diffraction peak and intensity of (022) diffraction peak observed in an XRD spectrum measured in a transmission geometry and in a manner that a 2θ axis makes 90° with a rolling direction, respectively.

### [Supplementary Note 17]

The collector aluminum foil according to Supplementary Note 15 or 16, wherein a value of I_{LR}(111)/I_{LR}(002) is 35 or greater, I_{LR}(111) and I_{LR}(002) being intensity of (111) diffraction peak and intensity of (002) diffraction peak observed in an XRD spectrum measured in a transmission geometry and in a manner that a 2θ axis makes 90° with a rolling direction, respectively.

### [Supplementary Note 18]

The collector aluminum foil according to Supplementary Note 17, wherein a value of I_{LR}(111)/I_{LR}(002) is 190 or greater, I_{LR}(111) and I_{LR}(002) being intensity of (111) diffraction peak and intensity of (002) diffraction peak observed in an XRD spectrum measured in a transmission geometry and in a manner that a 2θ axis makes 90° with a rolling direction, respectively.

### [Supplementary Note 19]

A collector aluminum foil having a value of I₁/I₀, out of two (022) diffraction peaks in a direction normal to a rolled surface, respectively derived from a CuKα1 radiation and a CuKα2 radiation of an incident X-ray, appearing in an XRD spectrum measured in a reflection geometry, I₀ being intensity of the (022) diffraction peak derived from the CuKα1 radiation, and I₁ being an intensity at a valley formed by an overlap of the two (022) diffraction peaks, being 0.22 or greater.

### [Supplementary Note 20]

A collector aluminum foil having a (022) X-ray rocking curve measured in a reflection geometry and in a manner that a 2θ axis makes 90° with a rolling direction, having a local minimum value at an incident angle of an incident X-ray in a range from 30° to 35°, and a first local maximum value and a second local maximum value at the incident angles in ranges from 15° to 20° and from 47° to 52°, respectively.

### [Supplementary Note 21]

The collector aluminum foil according to Supplementary Note 20, wherein the first local maximum value exists at the incident angle in a range from 16.0° to 19.0° and the second local maximum value exists at the incident angle in a range from 47.5° to 50.5°.

### [Supplementary Note 22]

The collector aluminum foil according to Supplementary Note 21, wherein a local minimum value exists at the incident angle in a range from 32.5° to 33.5°.

### [Supplementary Note 23]

A collector aluminum foil having a peak intensity corresponding to (122) or (123) preferred orientation, on a (022) X-ray rocking curve measured in a reflection geometry and in a manner that a 2θ axis makes 90° with a rolling direction, being greater than or equal to twice as large as an intensity at an incident angle corresponding to (011) preferred orientation on a (022) X-ray rocking curve measured in a reflection geometry and in a manner that a 2θ axis makes 90° with a rolling direction.

### [Supplementary Note 24]

A secondary battery including the collector aluminum foil according to any one of Supplementary Notes 1 to 23.

### [Supplementary Note 25]

An evaluation method of a collector aluminum foil including the successive steps of:

performing an XRD measurement on a collector aluminum foil after being cold-rolled; and

evaluating strength of the aluminum foil by at least one of following five values, the values including:

a value of I_{LR}(111)/I_{LR}(002), I_{LR}(111) and I_{LR}(002) being intensity of (111) diffraction peak and intensity of (002) diffraction peak in a rolling direction;

a value of I_{LR}(111)/I_{LR}(022), I_{LR}(111) and I_{LR}(022) being intensity of (111) diffraction peak and intensity of (022) diffraction peak in a rolling direction;

a value of I_{B}(022)/I_{B}(111), I_{B}(022) and I_{B}(111) being intensity of (022) diffraction peak and intensity of (111) diffraction peak in a direction normal to a rolled surface;

a value of I_{B}(022)/I_{B}(002), I_{B}(022) and I_{B}(002) being intensity of (022) diffraction peak and intensity of (002) diffraction peak in a direction normal to a rolled surface; and

a value of I₁/I₀, out of two (022) diffraction peaks in a direction normal to a rolled surface, respectively derived from a CuKα1 radiation and a CuKα2 radiation of an incident X-ray, I₀ being intensity of the (022) diffraction peak derived from the CuKα1 radiation, and I₁ being an intensity at a valley formed by an overlap of the two (022) diffraction peaks.

### [Supplementary Note 26]

The evaluation method of a collector aluminum foil according to Supplementary Note 25, wherein strength of the aluminum foil is evaluated to be high, by at least one value range of following five value ranges, the value ranges including

the value of I_{LR}(111)/I_{LR}(002) is 35 or greater,

the value of I_{LR}(111)/I_{LR}(022) is 760 or greater

the value of I_{B}(022)/I_{B}(111) is 200 or smaller,

the value of I_{B}(022)/I_{B}(002) is 12 or smaller, and

the value of I₁/I₀ is 0.22 or greater.

### [Supplementary Note 27]

An evaluation method of a collector aluminum foil including the successive steps of:

performing an XRD measurement on a collector aluminum foil after being cold-rolled; and

evaluating strength of the aluminum foil by at least one of following six values, the values including:

a value of I_{LR}(111)/I_{LR}(002), I_{LR}(111) and I_{LR}(002) being intensity of (111) diffraction peak and intensity of (002) diffraction peak in a rolling direction;

a value of I_{LR}(111)/I_{LR}(022), I_{LR}(111) and I_{LR}(022) being intensity of (111) diffraction peak and intensity of (022) diffraction peak in a rolling direction;

a value of I_{B}(022)/I_{B}(111), I_{B}(022) and I_{B}(111) being intensity of (022) diffraction peak and intensity of (111) diffraction peak in a direction normal to a rolled surface;

a value of I_{B}(022)/I_{B}(002), I_{B}(022) and I_{B}(002) being intensity of (022) diffraction peak and intensity of (002) diffraction peak in a direction normal to a rolled surface;

a value of I₁/I₀, out of two (022) diffraction peaks in a direction normal to a rolled surface, respectively derived from a CuKα1 radiation and a CuKα2 radiation of an incident X-ray, I₀ being intensity of the (022) diffraction peak derived from the CuKα1 radiation, and I₁ being an intensity at a valley formed by an overlap of the two (022) diffraction peaks; and

a ratio between a peak intensity, corresponding to (122) or (123) preferred orientation on a (022) X-ray rocking curve measured in a reflection geometry and in a manner that a 2θ axis makes 90° with a rolling direction, and a peak intensity at an incident angle corresponding to (011) preferred orientation on a (022) X-ray rocking curve measured in a reflection geometry and in a manner that a 2θ axis makes 90° with a rolling direction.

This application claims priority based on Japanese Patent Application No. 2013-186559 filed on Sep. 9, 2013 and Japanese Patent Application No. 2014-68369 filed on Mar. 28, 2014, the disclosure of which is hereby incorporated by reference thereto in its entirety.

### REFERENCE SIGNS LIST

1 (111) diffraction peak
2 (002) diffraction peak
3 (022) diffraction peak
4 (113) diffraction peak
5 (222) diffraction peak
6 (133) diffraction peak
7 (024) diffraction peak
8 (224) diffraction peak
9 (022) diffraction peak before heat treatment
10 (022) diffraction peak after 150° C. heat treatment
11 (022) diffraction peak after 200° C. heat treatment
12 (022) diffraction peak after 270° C. heat treatment
13 Diffraction peak by a CuKα1 characteristic X-ray
14 Diffraction peak by a CuKα2 characteristic X-ray
15 Hardness index of aluminum foil A1, heat-treated at each temperature
16 Hardness index of aluminum foil B1, heat-treated at each temperature
17 Slip plane of dislocation (hkl)
18 Slip direction of dislocation [uvw]
19 Rocking curve of aluminum foil A1
20 Rocking curve of aluminum foil B1
21 Rocking curve of aluminum foil A2
22 Rocking curve of aluminum foil A3
23 Rocking curve of aluminum foil A4
24 Rocking curve of aluminum foil B2
25 Rocking curve of aluminum foil B3
26 Rocking curve of aluminum foil B4

What is claimed is:

1. A collector aluminum foil wherein a value of I_{B}(022)/I_{B}(111) is 200 or smaller, I_{B}(022) and I_{B}(111) being intensity of (022) diffraction peak and intensity of (111) diffraction peak observed in an XRD spectrum measured in a reflection geometry, respectively.

2. The collector aluminum foil according to claim 1, wherein a value of I_{B}(022)/I_{B}(002) is 12 or smaller, the I_{B}(022) and I_{B}(002) being intensity of (022) diffraction peak and intensity of (002) diffraction peak observed in an XRD spectrum measured in a reflection geometry, respectively.

3. A collector aluminum foil wherein a value of I_{B}(022)/I_{B}(002) is 12 or smaller, I_{B}(022) and I_{B}(002) being intensity of (022) diffraction peak and intensity of (002) diffraction peak observed in an XRD spectrum measured in a reflection geometry, respectively.

4. The collector aluminum foil according to claim 3, wherein a value of I_{B}(022)/I_{B}(111) is 200 or smaller, the I_{B}(022) and I_{B}(111) being intensity of (022) diffraction peak and intensity of (111) diffraction peak observed in an XRD spectrum measured in a reflection geometry, respectively.

5. A collector aluminum foil wherein a value of I_{LR}(111)/I_{LR}(002) being 35 or greater, I_{LR}(111) and I_{LR}(002) being intensity of (111) diffraction peak and intensity of (002) diffraction peak observed in an XRD spectrum measured in a transmission geometry and in a manner that a 28 axis makes 90° with a rolling direction, respectively.

6. The collector aluminum foil according to claim 5, wherein a value of I_{LR}(111)/I_{LR}(022) is 760 or greater, I_{LR}(111) and I_{LR}(022) being intensity of (111) diffraction peak and intensity of (022) diffraction peak observed in an XRD spectrum measured in a transmission geometry and in a manner that a 28 axis makes 90° with a rolling direction, respectively.

7. A collector aluminum foil having a (022) X-ray rocking curve measured in a reflection geometry and in such a manner that a 28 axis makes 90° with a rolling direction, the (022) X-ray rocking curve having a local minimum value at an incident angle of an incident X-ray in a range from 30° to 35°, and a first local maximum value and a second local maximum value at the incident angles in ranges from 15° to 20° and from 47° to 52°, respectively.

8. A collector aluminum foil having peak intensity corresponding to (122) or (123) preferred orientation, on a (022) X-ray rocking curve measured in a reflection geometry and in such a manner that a 28 axis makes 90° with a rolling direction, being greater than or equal to twice as large as a peak intensity at an incident angle corresponding to (011) preferred orientation, on a (022) X-ray rocking curve measured in a reflection geometry and in such a manner that a 28 axis makes 90° with a rolling direction.

9. A collector aluminum foil wherein an XRD spectrum measured thereon in a reflection geometry has two (022) diffraction peaks in a direction normal to a rolled surface respectively caused by a CuKα1 radiation and a CuKα2 radiation of an incident X-ray, and a value of I₁/I₀ is 0.22 or greater, I₀ being intensity of the (022) diffraction peak caused by the CuKα1 radiation, I₁ being intensity at a valley formed by an overlap of the two (022) diffraction peaks.

10. An evaluation method of a collector aluminum foil comprising:
performing XRD measurement on the collector aluminum foil after being cold-rolled; and
evaluating strength of the aluminum foil by using at least one of following six values, the six values including:
a value of I_{LR}(111)/I_{LR} (002), I_{LR} (111) and I_{LR} (002) being intensity of (111) diffraction peak and intensity of (002) diffraction peak in a rolling direction;
a value of I_{LR} (111)/I_{LR} (022), I_{LR} (111) and I_{LR} (022) being intensity of (111) diffraction peak and intensity of (022) diffraction peak in a rolling direction;
a value of I_{B}(022)/I_{B}(111), I_{B}(022) and I_{B}(111) being intensity of (022) diffraction peak and intensity of (111) diffraction peak in a direction normal to a rolled surface;
a value of I_{B}(022)/I_{B}(002), I_{B}(022) and I_{B}(002) being intensity of (022) diffraction peak and intensity of (002) diffraction peak in a direction normal to a rolled surface;
a value of I₁/I₀, out of two (022) diffraction peaks in a direction normal to a rolled surface, observed in an XRD spectrum measured in a reflection geometry, respectively derived from a CuKα1 radiation and a CuKα2 radiation of an incident X-ray, I₀ being intensity of the (022) diffraction peak derived from the CuKα1 radiation, and I₁ being intensity at a valley formed by an overlap of the two (022) diffraction peaks; and
a ratio between a peak intensity, corresponding to (122) or (123) preferred orientation on a (022) X-ray rocking curve measured in a reflection geometry and in such a manner that a 28 axis makes 90° with the rolling direction, and intensity at an incident angle corresponding to (011) preferred orientation on a (022) X-ray rocking curve measured in a reflection geometry and in such a manner that a 28 axis makes 90° with the rolling direction.

11. A secondary battery comprising a collector aluminum foil as an electrode collector wherein the collector aluminum foil has at least one of following six characteristics, the six characteristics including:
a value of I_{LR}(111)/I_{LR}(002) is 35 or greater, I_{LR}(111) being intensity of a (111) diffraction peak in a rolling direction, I_{LR}(002) being intensity of a (002) diffraction peak in the rolling direction observed in an XRD spectrum measured in a transmission geometry and in a manner that a 28 axis makes 90° with a rolling direction, respectively;
a value of I_{LR}(111)/I_{LR}(022) is 760 or greater, I_{LR}(111) being intensity of the (111) diffraction peak in the rolling direction, I_{LR}(022) being intensity of a (022) diffraction peak in the rolling direction observed in an XRD spectrum measured in a transmission geometry and in a manner that a 28 axis makes 90° with a rolling direction, respectively;
a value of I_{B}(022)/I_{B}(111) is 200 or smaller, I_{B}(022) and I_{B}(111) being intensity of a (022) diffraction peak and intensity of a (111) diffraction peak in a direction normal to a rolled surface, observed in an XRD spectrum measured in a reflection geometry, respectively;
a value of I_{B}(022)/I_{B}(002) is 12 or smaller, I_{B}(022) and I_{B}(002) being the intensity of the (022) diffraction peak and intensity of a (002) diffraction peak in the direction normal to the rolled surface, observed in an XRD spectrum measured in a reflection geometry, respectively;
a value of I₁/I₀, out of two (022) diffraction peaks in the direction normal to the rolled surface, observed in an XRD spectrum measured in a reflection geometry, respectively caused by a CuKα1 radiation ray and a CuKα2 radiation ray of an incident X-ray, is 0.22 or greater, I₀ being intensity of the (022) diffraction peak caused by the CuKα1 radiation ray, I₁ being intensity at a valley formed by an overlap of the two (022) diffraction peaks; and
peak intensity corresponding to (122) or (123) preferred orientation, on a (022) X-ray rocking curve measured in a reflection geometry and in such a manner that a 28 axis makes 90° with the rolling direction, is greater than or equal to twice the peak intensity at an incident angle corresponding to (011) preferred orientation on a (022) X-ray rocking curve measured in a reflection geometry and in such a manner that a 28 axis makes 90° with the rolling direction.
